(19) United States
(12) Patent Application Publication
(10) Pub. No.: US 2024/0193586 A1
(43) Pub. Date: Jun. 13, 2024

(54) INFORMATION PROCESSING DEVICE, INFORMATION PROCESSING METHOD, AND INFORMATION PROCESSING PROGRAM

(71) Applicant: Sony Group Corporation, Tokyo (JP)

(72) Inventors: Takahiro NOHARA, Tokyo (JP); Yuya ISHIKAWA, Tokyo (JP)

(73) Assignee: Sony Group Corporation, Tokyo (JP)

(21) Appl. No.: 18/286,901

(22) PCT Filed: Feb. 24, 2022
(86) PCT No.: PCT/JP2022/007575

§ 371 Date: Oct. 13, 2023

(30) Foreign Application Priority Data
Apr. 22, 2021 (JP) 2021-072915

(51) Int. Cl. G06Q 20/36; G06Q 20/40; H04L 9/00

(52) U.S. Cl. CPC G06Q 20/367; G06Q 20/401; H04L 9/50

(57) ABSTRACT

An information processing device (100) according to the present disclosure includes: an issuing unit (131) that issues a non fungible token (NFT) in a blockchain; an acquisition unit (132) that acquires information on a user who owns the NET issued by the issuing unit; and a transmission unit (134) that transmits a ticket associated with the NFT to the user based on the information acquired by the acquisition unit.

### FIELD

The present disclosure relates to an information processing device, an information processing method, and an information processing program. Specifically, the present disclosure relates to ticket processing using a non fungible token (NFT) in a blockchain.

### BACKGROUND

In recent years, blockchains represented by Bitcoin and Ethereum have been actively used in information processing. The blockchains are characterized by being resistant to data falsification due to the mechanisms of the blockchains, and being excellent in data traceability since a transaction history remains.

For example, a technique of identifying a contributor to processing and determining a level of the contributor by tracking collaborative creation processing is known as a technique using a blockchain.

### CITATION LIST

### Patent Literature

Patent Literature 1: JP 2020-173803 A

### SUMMARY

### Technical Problem

Conventional techniques can clarify attribution of a contribution that has conventionally been liable to be unclear by tracking a transaction by taking advantage of a feature of a blockchain.

The conventional techniques relate to tracking of a transaction. When applied to a ticket system, the techniques play a useful role in inhibition of ticket resale and the like. In the conventional techniques, however, it is difficult for a user to use a ticket as in a case where the ticket is physically issued, for example, to assign the ticket to a third party or to handle a used ticket as a coupon.

Therefore, the present disclosure proposes an information processing device, an information processing method, and an information processing program capable of improving convenience of a user related to a ticket.

### Solution to Problem

In order to solve the above problems, an information processing device according to an embodiment of the present disclosure includes an issuing unit that issues a non fungible token (NFT) in a blockchain, an acquisition unit that acquires information on a user who owns the NFT issued by the issuing unit, and a transmission unit that transmits a ticket associated with the NFT to the user based on the information acquired by the acquisition unit.

### BRIEF DESCRIPTION OF DRAWINGS

FIG. 1 schematically illustrates an information processing system according to an embodiment.

FIG. 2 is a view (1) illustrating a user interface according to the embodiment.

FIG. 3 is a view (2) illustrating the user interface according to the embodiment.

FIG. 4 is a view (3) illustrating the user interface according to the embodiment.

FIG. 5 is a view (4) illustrating the user interface according to the embodiment.

FIG. 6 is a view (5) illustrating the user interface according to the embodiment.

FIG. 7 is a view (6) illustrating the user interface according to the embodiment.

FIG. 8 is a view (7) illustrating the user interface according to the embodiment.

FIG. 9 is a view (8) illustrating the user interface according to the embodiment.

FIG. 10 is a view (9) illustrating the user interface according to the embodiment.

FIG. 11 is a view (10) illustrating the user interface according to the embodiment.

FIG. 12 illustrates a configuration example of an information processing system according to the embodiment.

FIG. 13 illustrates a configuration example of an information processing device according to the embodiment of the present disclosure.

FIG. 14 illustrates one example of a ticket information storage unit according to the embodiment of the present disclosure.

FIG. 15 illustrates one example of a user information storage unit according to the embodiment of the present disclosure.

FIG. 16 is a flowchart (1) illustrating a procedure of information processing according to the embodiment.

FIG. 17 is a flowchart (2) illustrating the procedure of the information processing according to the embodiment.

FIG. 18 is a flowchart (3) illustrating the procedure of the information processing according to the embodiment.

FIG. 19 is a flowchart (4) illustrating the procedure of the information processing according to the embodiment.

FIG. 20 is a flowchart (5) illustrating the procedure of the information processing according to the embodiment.

FIG. 21 is a hardware configuration diagram illustrating one example of a computer that implements the function of an information processing device.

### DESCRIPTION OF EMBODIMENTS

An embodiment of the present disclosure will be described in detail below with reference to the drawings. Note that, in the following embodiment, the same reference signs are attached to the same parts to omit duplicate description.

The present disclosure will be described in the following item order.

1. Embodiment

1-1. One Example of Information Processing According to Embodiment

1-2. Configuration of Information Processing System According to Embodiment

1-3. Configuration of Information Processing Device According to Embodiment

1-4. Procedure of Information Processing According to Embodiment

1-5. Variation of Embodiment

1-5-1. Operation as Information Processing System

1-5-2. Use of DID

1-5-3. Mode of Secondary Distribution

2. Other Embodiments

3. Effects of Information Processing Device According to Present Disclosure

4. Hardware Configuration

### 1. Embodiment

### 1-1. One Example of Information Processing According to Embodiment

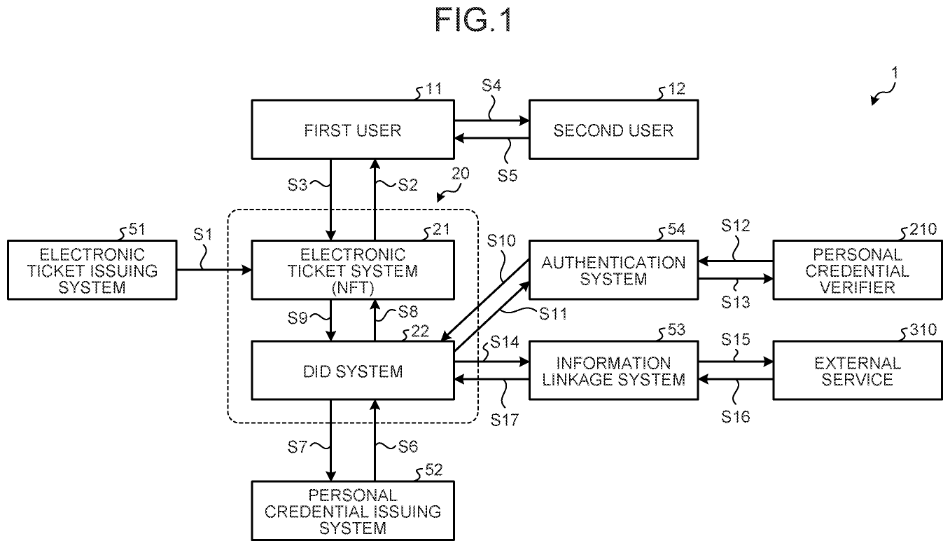

FIG. 1 schematically illustrates an information processing system 1 according to an embodiment. The information processing system 1 is a ticket system that uses a non fungible token (NFT) issued on a blockchain as a ticket. FIG. 1 is a schematic block diagram illustrating processing executed in the information processing system 1.

As illustrated in FIG. 1, the information processing system 1 includes a first user 11, a second user 12, a blockchain 20, an electronic ticket system 21, a decentralized identity (DID) system 22, an electronic ticket issuing system 51, a personal credential issuing system 52, an information linkage system 53, an authentication system 54, a personal credential verifier 210, and external service 310. Note that each system in FIG. 1 conceptually indicates a function of the information processing system 1, and can have various modes depending on embodiments. For example, a system may be one or two or more terminal devices, or may be a program that operates on the terminal device.

The first user 11 and the second user 12 are purchasers who purchase tickets for participating in events and the like in the information processing system 1 according to the embodiment. Furthermore, the first user 11 and the second user 12 use service or applications provided in association with the events and the like. In the example of FIG. 1, the first user 11 purchases a ticket by using the information processing system 1, and the second user 12 secondarily acquires the ticket purchased by the first user 11.

Note that, in the present specification, a “user” may mean a “terminal device (e.g., smartphone) used by a user”. For example, “transmitting an electronic ticket to a user” actually means “transmitting an electronic ticket to a terminal device used by a user”.

The blockchain 20 refers to a decentralized ledger system in which a plurality of participants (nodes) connected to a network share data. In the example of FIG. 1, the blockchain 20 is a private blockchain managed by an administrator of the information processing system 1. Note that various known techniques may be used for issuance of various tokens including an NFT (execution of transactions) in the blockchain 20, consensus building processing for token approval, the structure of the blockchain 20, and the like.

The electronic ticket system 21 manages information related to an NFT on the blockchain 20. The NFT is issued and managed by a program (referred to as smart contract) executed in the blockchain 20.

For example, a node (electronic ticket system 21 in example of FIG. 1) that participates in the blockchain 20 describes a source code related to NFT issuance, compiles the source code, and transmits the compiled code to a mining pool in the blockchain 20. When data is stocked in the mining pool, the node of the blockchain 20 gives a block header other than a number used once (nonce) to the data to generate a block. When a correct nonce is found by a miner, the block on the mining pool is given an address, and broadcast throughout the blockchain 20. This makes deployment of smart contracts to the blockchain 20 successful, and an NFT is issued. An owner of the issued NFT can be transferred or a rule for the issued NFT can be set by using decentralized applications (DApps) that operate on the blockchain 20.

The DID system 22 manages user information in predetermined service on the blockchain 20. For example, the DID system 22 manages, by a decentralized identity (DID) method, personal identification information of a user who uses service related to a ticket issued by the electronic ticket system 21. Note that the DID system 22 may be constructed on a blockchain different from the blockchain 20.

When receiving a ticket issuance request, the electronic ticket issuing system 51 performs control to issue an NFT on the blockchain 20.

The personal credential issuing system 52 registers user information managed by the DID system 22, and acquires the user information managed by the DID system 22.

The information linkage system 53 performs processing of linking the user information managed by the DID system 22 with the external service 310.

When a ticket issued by the information processing system 1 is used, the authentication system 54 authenticates validity of the ticket and identity information of a user.

The personal credential verifier 210 is, for example, a host of an event related to a ticket, and authenticates identity of a user who owns a ticket in an event venue or the like. For example, in a venue where the event is held, the personal credential verifier 210 verifies whether or not the user has a legitimate qualification for participating in the event based on identity information of the user presented by the authentication system 54.

The external service 310 is the generic name for service related to tickets, service providers that provide service, and information processing devices used by the service providers.

The above are the components of the information processing system 1. Processing of the information processing system 1, which is a ticket system using an NFT, will now be described with reference to FIG. 1. Note that the pieces of processing (e.g., Step S1) in FIG. 1 are not necessarily required to be executed in the order of reference numerals.

In the example of FIG. 1, the information processing system 1 issues a ticket for an event related to a predetermined idol or character. Such an idol or character has members (users) in a fan club, a related game application, and the like. The DID system 22 manages information on the members.

For example, it is assumed that the personal credential verifier 210, who is a host of an event, plans an event of an idol or a character and desires to issue a ticket for the event. In this case, the electronic ticket issuing system 51 receives a ticket issuance request from the host of the event. Note that a person or a plurality of users participates in the event. The event refers to a music live show, a concert, a gathering of a fan club of an idol or a game, and the like. The event may be actually held in a theater, a multipurpose hall, and the like, or may be an online event held on a network.

When receiving the ticket issuance request, the electronic ticket issuing system 51 sets a rule in complying with intention of the host, and then causes the electronic ticket system 21 to issue an NFT (Step S1).

The electronic ticket system 21 describes a smart contract for issuing the NFT in conformity with the rule set by the electronic ticket issuing system 51. For example, the electronic ticket system 21 defines a rule related to a purchaser selling a ticket to another person (secondary distribution). Specifically, the electronic ticket system 21 sets whether or not to permit a purchaser selling a ticket to another person, an assigned time when the secondary distribution can be performed, a range of targets (e.g., limited to fan club members) of the secondary distribution, and the like. Alternatively, the electronic ticket system 21 sets a fee to be returned to a right holder (e.g., host and author of content used in event) involved in an event in a case where a ticket is secondarily distributed. Furthermore, the electronic ticket system 21 may also define a condition related to an upper limit amount and a lower limit amount in a sales amount at the time when a ticket is secondarily distributed.

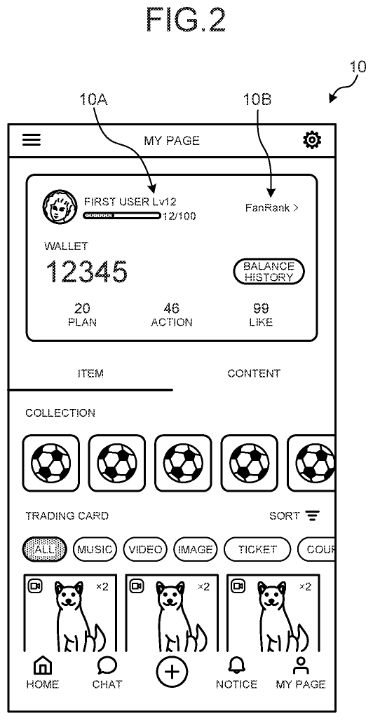

Information to be presented to the purchaser among rules set by the electronic ticket system 21 is presented on a user interface illustrated in FIG. 2 and subsequent drawings and the like, for example, when a ticket is sold (Step S2). Note that the electronic ticket system 21 may present not only a rule related to transfer of a ticket (NFT) but general information such as details, the date, and a venue of an event. The electronic ticket issuing system 51 can optionally change the settings of the details, the date, and a venue of an event based on, for example, intention of the host.

Note that the first user 11 and the second user 12 are members of a fan club or a fan community site of an idol who appears in an event, a game application related to the idol, and the like (hereinafter, collectively referred to as “service”). Event information related to a ticket is presented or application of a ticket is received via a smartphone application provided by a service side, for example. The DID system 22 manages information on the first user 11 and the second user 12. For example, the DID system 22 delivers personal identification information (hereinafter, referred to as “user ID”) to a user who uses the service. The DID system 22 can uniquely identify the user by associating an address on the blockchain 20 with the user ID.

Furthermore, the DID system 22 may store a history of actions of the user in the service in association with the user ID. For example, the DID system 22 stores information such as a record of participation in the fan club, use time and the number of times of use of the application, and an amount of charge to the service so far. Then, the DID system 22 refers to all entire pieces of data linked with the user ID, scores a degree of activity of each user, and calculates a so-called a credibility score of the user. The electronic ticket issuing system 51 performs processing of, for example, adjusting a ticket winning probability of the user based on the credibility score of the user.

The first user 11 who wants to purchase a ticket requests a ticket purchase via a user interface (Step S3). When the ticket purchase is authenticated, the electronic ticket system 21 gives an NFT associated with the ticket to the first user 11. Specifically, the electronic ticket system 21 transfers owner information of the NFT associated with the ticket to a wallet of the blockchain 20 owned by the first user 11.

Thereafter, it is assumed that the first user 11 desires to secondarily sell his/her ticket. For example, the first user 11 can sell the ticket that the first user 11 himself/herself purchased by putting up the ticket on a platform in which NFTs can be sold. In the example of FIG. 1, the first user 11 sells the ticket to the second user 12 (Step S4).

The second user 12 acquires the ticket from the first user 11 (Step S5). Specifically, in the transactions of the blockchain 20, the second user 12 transfers the owner information of the NFT owned by the first user 11 to a wallet of the second user 12 himself/herself. Such transfer of a ticket is achieved by, for example, functions of DApps that operate on the blockchain 20.

At this time, the first user 11 or the second user 12 pays a fee and the like related to secondary distribution defined in the NFT. For example, such payment may be made by crypto-assets (virtual currency) of the blockchain 20 recorded on the wallet of the first user 11 or the second user 12 in accordance with the description of the smart contract, or may be made by predetermined legal tender.

Note that the personal credential issuing system 52 managed by a service operating side or the like preliminarily issues the user ID on the blockchain 20 (Step S6). Furthermore, the personal credential issuing system 52 can query the DID system 22 as needed to receive presentation of personal credentials of a user who uses the service (Step S7).

The personal credentials are, for example, information required for achieving electronic know your customer (eKYC) of a user. That is, the personal credentials are information for confirming the identity of a user, and includes, for example, an address, a name, and face image data of the user. Note that the personal credentials may be other than the exemplified information as long as the personal credentials are sufficient for confirming the identity of a user. Furthermore, the personal credential issuing system 52 may acquire the personal credentials in response to an input operation of the first user 11 when the first user 11 requests a ticket purchase (Step S2).

The ticket purchase requests from the first user 11 and the second user 12 are linked with the user information managed by the DID system 22. For example, when a user logs in to an application of a fan club and requests a ticket purchase, the DID system 22 transmits the information to the electronic ticket system 21 (Step S8).

When the ticket is purchased, that is, owner information of an NFT is transferred, the electronic ticket system 21 transmits the information to the DID system 22 (Step S9). The DID system 22 stores the user ID and the owner information of the NFT in association with each other.

Subsequently, processing in a case where a ticket is actually used will be described. The second user 12 who intends to use a ticket requests display of the ticket on a terminal. Such a request is transmitted from the personal credential issuing system 52 to the DID system 22, for example. When receiving the request, the DID system 22 refers to a user ID, and verifies owner information of an NFT associated with the ticket. Then, when verifying that the second user 12 is an owner of the NFT associated with the ticket, the DID system 22 transmits the ticket displayed by a two-dimensional code such as a QR code (registered trademark) to the second user 12.

When the second user 12 reads the QR code on the terminal, the authentication system 54 requests the DID system 22 to present identity confirmation information of the second user 12 based on the QR code indicated by the second user 12 (Step S10).

The authentication system 54 acquires the identity confirmation information transmitted from the DID system 22 (Step S11). Then, when the personal credential verifier 210 who is a host of an event requests presentation of the identity confirmation information (Step S12), the authentication system 54 presents the identity confirmation information of the second user 12 (Step S13). This enables the personal credential verifier 210 to confirm that the user who has presented the ticket is the second user 12 himself/herself.

Subsequently, processing in a case where, when a ticket is used, the external service 310 reuses the used ticket will be described. Note that the external service 310 is a generic term for pieces of service operated by a person who desires to attract a participant of an event to his/her business by offering some benefits to the participant, such as a shop near an event venue and a business operator that provides service related to the event. Note that the same host as the host of the event may operate the external service 310.

For example, the information linkage system 53 acquires, from the DID system 22, information such as the date, a venue, the scale, details, the number of participants, and the like of the event to be held based on information associated with an NFT and the ticket (Step S14). The information linkage system 53 provides the acquired information to the external service 310 (Step S15).

The external service 310 sets a benefit to be offered to a user who has participated in the event, and notifies the information linkage system 53 of the set information (Step S16). For example, the external service 310 gives a notification that the external service 310 will offer a benefit such as a discount coupon that can be used by the user who has participated in the event and an item that can be used in a game.

When receiving the notification of a benefit offer from the external service 310, the information linkage system 53 transmits the information to the DID system 22 (Step S17). The DID system 22 stores the benefit in association with the ticket and the NFT. This enables the user who has participated in the event to enjoy a benefit transmitted to the user himself/herself based on the owner information of the NFT, for example.

Processing of the information processing system 1 has been outlined above with reference to FIG. 1. Subsequently, how the user actually uses the ticket on the user interface of the terminal operated by the user (hereinafter, referred to as user terminal 10) will be described in detail with reference to FIGS. 2 to 11.

FIG. 2 is a view (1) illustrating a user interface according to the embodiment. FIG. 2 illustrates the user interface of an application provided by the information processing system 1 displayed on a screen of the user terminal 10. The application in FIG. 2 is, for example, a fan community application of, for example, a game character and an idol who appears in an event. A display screen of the application includes a wallet of a user and information on electronic assets such as trading cards and items acquired by the user through activities so far.

In the example of FIG. 2, the user of the user terminal 10 is logged into service. Display 10A in FIG. 2 indicates a username (“first user” in example of FIG. 2). Furthermore, as illustrated in display 10B, the user interface includes a button for displaying a credibility score of a user in the service. The credibility score is called a fan rank.

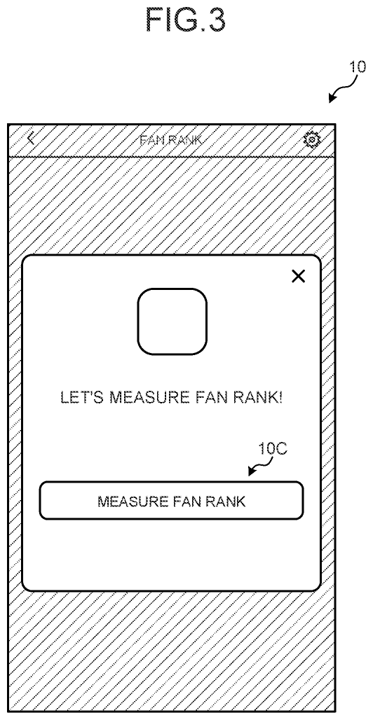

When the user presses the display 10B, the user interface shifts to FIG. 3. FIG. 3 is a view (2) illustrating the user interface according to the embodiment. FIG. 3 illustrates display 10C on the screen of the user terminal 10. The display 10C prompts measurement of the fan rank.

When the user presses the display 10C, the DID system 22 refers to an activity history in the service of the user so far, and calculates the credibility score of the user. The credibility score is referred to as a fan rank. The user terminal 10 displays the credibility score of which the DID system 22 has notified the user terminal 10 on the user interface. Note that the information processing system 1 may provide a condition that, for example, application for a ticket is received only from a user who has measured the fan rank. This enables the information processing system 1 to inhibit, for example, ticket application of an unauthorized reseller who intends to purchase the ticket for resale despite that fact that the reseller does not usually use the service.

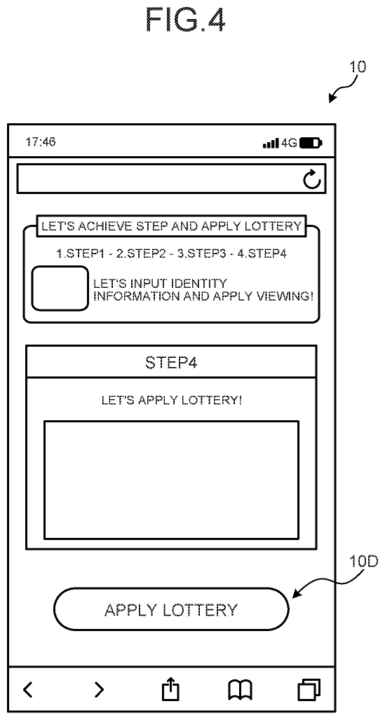

When the fan rank measurement is a condition for ticket application, the user interface shifts to FIG. 4 after the fan rank measurement. FIG. 4 is a view (3) illustrating the user interface according to the embodiment. FIG. 4 illustrates display 10D displayed on the screen of the user terminal 10. The display 10D is displayed for applying a lottery for participating in an event, that is, for requesting a ticket purchase.

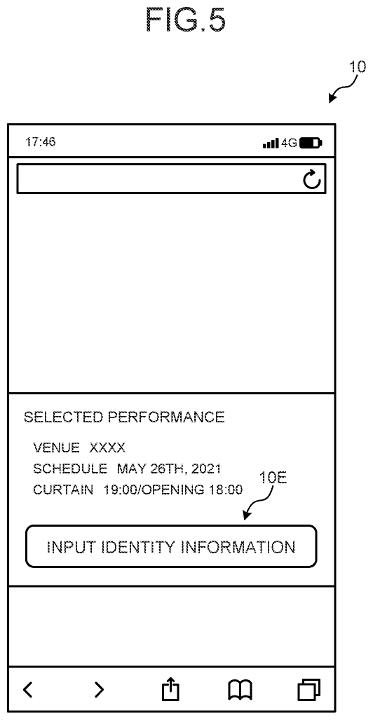

When the user presses the display 10D, the user interface shifts to FIG. 5. FIG. 5 is a view (4) illustrating the user interface according to the embodiment. FIG. 5 illustrates information on the event which the user intends to participate in and display 10E for requesting input of identity information displayed on the screen of the user terminal 10.

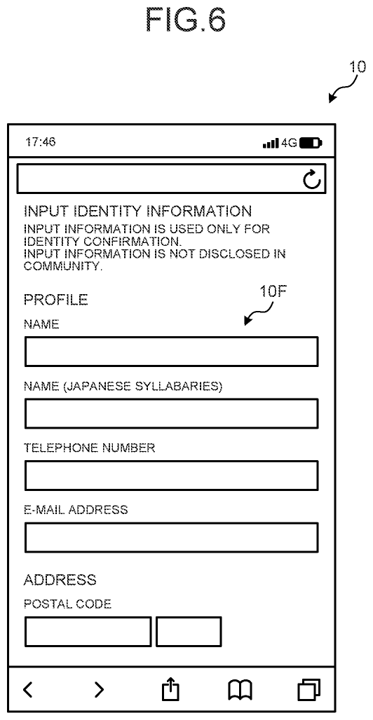

When the user presses the display 10E, the user interface shifts to FIG. 6. FIG. 6 is a view (5) illustrating the user interface according to the embodiment. FIG. 6 illustrates display 10F displayed on the screen of the user terminal 10. The display 10F is a form for inputting a profile (e.g., name, telephone number, e-mail address, and address), which is identity confirmation information of the user.

When the user inputs the identity confirmation information, the information is transmitted to the personal credential issuing system 52. Thereafter, as illustrated in Step S6 of FIG. 1, the personal credential issuing system 52 manages the identity confirmation information and the user ID in association with each other in the DID system 22.

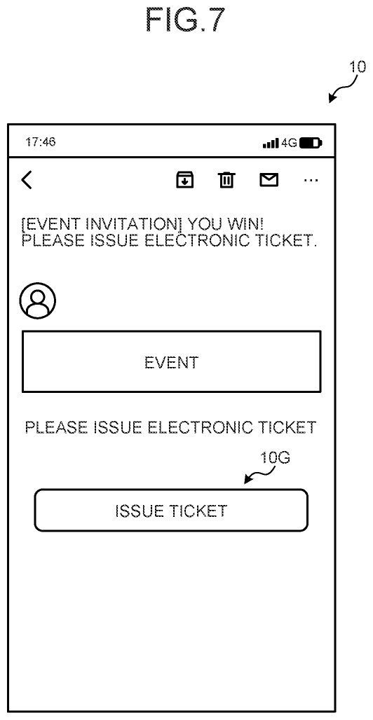

Subsequently, an example of the user interface in a case where the user purchases the ticket will be described. FIG. 7 is a view (6) illustrating the user interface according to the embodiment. FIG. 7 illustrates winning of the ticket and display 10G for issuing the ticket displayed on the screen of the user terminal 10.

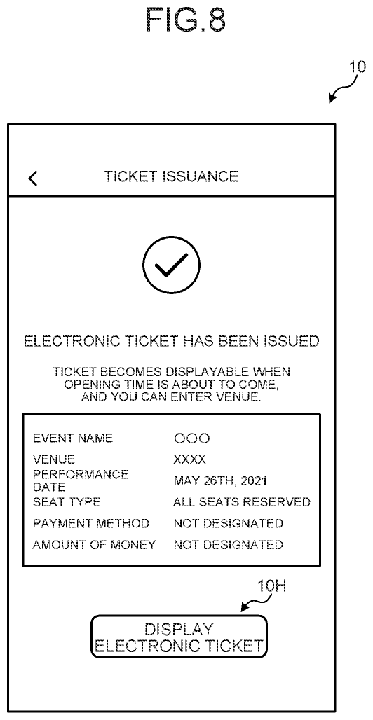

When the user presses the display 10G, the user interface shifts to FIG. 8. FIG. 8 is a view (7) illustrating the user interface according to the embodiment. FIG. 8 illustrates issuance of an electronic ticket and display 10H for displaying the electronic ticket displayed on the screen of the user terminal 10.

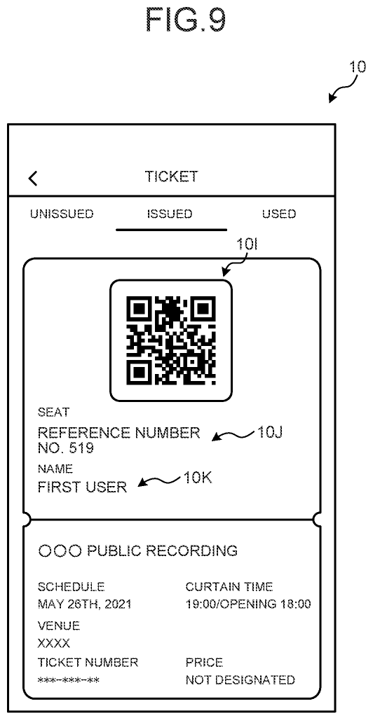

When the user presses the display 10H, the user interface shifts to FIG. 9. FIG. 9 is a view (8) illustrating the user interface according to the embodiment. FIG. 9 illustrates display 101 of the ticket, display 10J, and display 10K displayed on the screen of the user terminal 10. The display 101 is indicated by a QR code. The display 10J indicates a seat number in the event. The display 10K indicates a username.

For example, when the QR code displayed by the user terminal 10 is read by a reader installed in the venue, the authentication system 54 receives a request related to identity confirmation of the user from the user terminal 10. Then, when the identity of the user is successfully confirmed, the authentication system 54 transmits the identity confirmation information of the user to the personal credential verifier 210. At this time, the authentication system 54 may transmit the identity confirmation information of the user itself or “information indicating that the identity of the user has been verified” to the personal credential verifier 210. In this case, information indicating that identity authentication of the user has been completed is displayed on the user terminal 10. The user can prove his/her identity to the host by presenting information indicating that the identity of the user has been appropriately confirmed to the host.

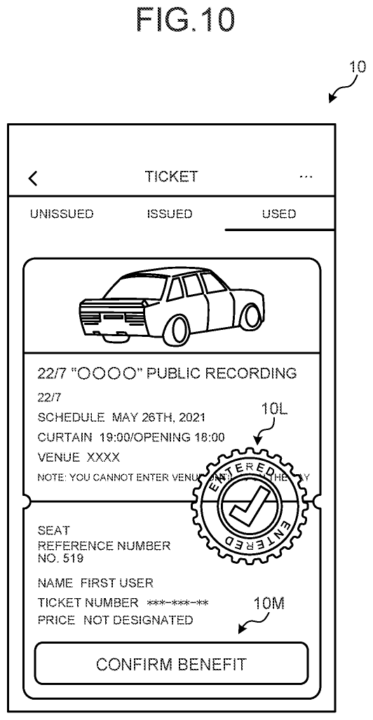

Subsequently, an example of the user interface after the user uses the ticket will be described. FIG. 10 is a view (9) illustrating the user interface according to the embodiment. FIG. 10 illustrates display 10L and display 10M displayed on the screen of the user terminal 10. The display 10L indicates that the ticket has been used. The display 10M is displayed for confirming a benefit offered to the ticket.

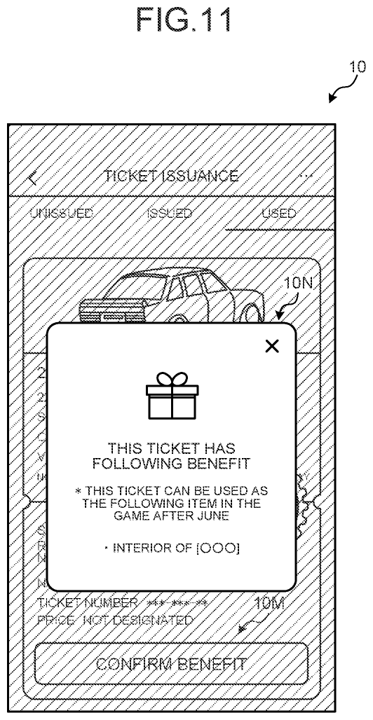

When the user presses the display 10M, the user interface shifts to FIG. 11. FIG. 11 is a view (10) illustrating the user interface according to the embodiment. FIG. 11 illustrates display 10N displayed on the screen of the user terminal 10. The display 10N indicates that a benefit has been offered to the ticket. The user can recognize, via the user interface, that the ticket has been used, that a benefit has been offered to the ticket, and a method of using the benefit, for example.

As described above with reference to FIGS. 1 to 11, the information processing system 1 according to the present disclosure issues an NFT in the blockchain 20, acquires information on a user who owns the issued NFT, and transmits a ticket associated with the NFT to the user based on the acquired information.

That is, the information processing system 1 associates the NFT with the ticket. The NFT is the only data in the world not capable of being duplicated. The NFT is also data in which a transfer history can be referred to on the blockchain. This enables the information processing system 1 to inhibit unauthorized resale and unauthorized copying of a ticket and provide a ticket system capable of being used in a market in secondary distribution (secondary market). Specifically, even when a ticket is sold and bought in the secondary market, the information processing system 1 can return a revenue in the secondary market to the host, the author, and the like by setting a rule to the NFT. As described above, the information processing system 1 can improve convenience of the user in relation to the ticket.

### 1-2. Configuration of Information Processing System According to Embodiment

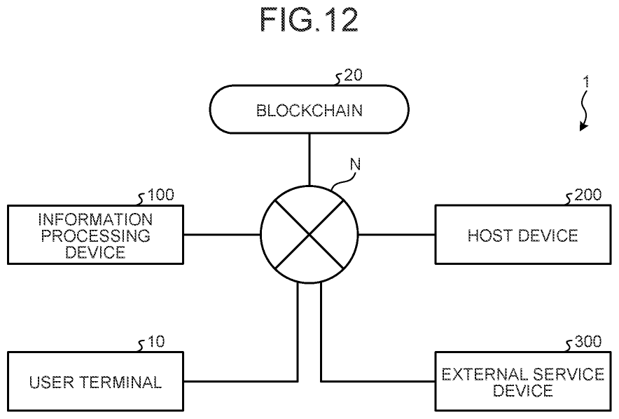

Next, a configuration of the information processing system 1 that executes information processing according to the embodiment will be described. FIG. 12 illustrates a configuration example of the information processing system 1 according to the embodiment of the present disclosure. FIG. 12 illustrates one example of a device configuration for achieving a processing concept of the information processing system 1 in FIG. 1.

As illustrated in FIG. 12, the information processing system 1 includes the user terminal 10, the blockchain 20, an information processing device 100, a host device 200, and an external service device 300. These various devices are communicably connected by wire or wirelessly via a network N (e.g., Internet). Note that the number of devices included in the information processing system 1 in FIG. 12 is not limited to the illustrated number. For example, the information processing system 1 may include a plurality of user terminals 10. Furthermore, each device in FIG. 12 is conceptual, so that, for example, the information processing device 100 may include a plurality of devices linked with each other.

The user terminal 10 is an information processing device such as a smartphone, a desktop personal computer (PC), a notebook PC, a tablet terminal, and a wearable device. In the processing of the information processing system 1, the user terminal 10 corresponds to the first user 11 and the second user 12 in FIG. 1.

The blockchain 20 is a decentralized ledger system in which a plurality of nodes share data. In the example of the present disclosure, the blockchain 20 is a private blockchain managed by an administrator of the information processing system 1. The blockchain 20 stores, for example, information on an NFT issued in response to a request from the information processing device 100 and a result of transaction of each token. Furthermore, the blockchain 20 may store a user ID in service, identity confirmation information, and the like.

The information processing device 100 is a terminal device or a server used by an operator or an administrator of the ticket system according to the present disclosure. In the processing of the information processing system 1, the information processing device 100 corresponds to the electronic ticket issuing system 51, the personal credential issuing system 52, the information linkage system 53, the authentication system 54, the electronic ticket system 21, and the DID system 22 in FIG. 1. That is, the information processing device 100 may function as a server that manages ticket information, and may function as a node that shares information on the blockchain 20.

The host device 200 is a terminal device or a server used by the side of the host of the event according to the present disclosure. In the processing of the information processing system 1, the host device 200 corresponds to the personal credential verifier 210 in FIG. 1. Note that the host device 200 may have a function as the authentication system 54 in FIG. 1.

The external service device 300 is a terminal device or a server used by a business operator that provides service related to the event according to the present disclosure. In the processing of the information processing system 1, the external service device 300 corresponds to the external service 310 in FIG. 1. Note that the external service device 300 may have a function as the information linkage system 53 in FIG. 1.

### 1-3. Configuration of Information Processing Device According to Embodiment

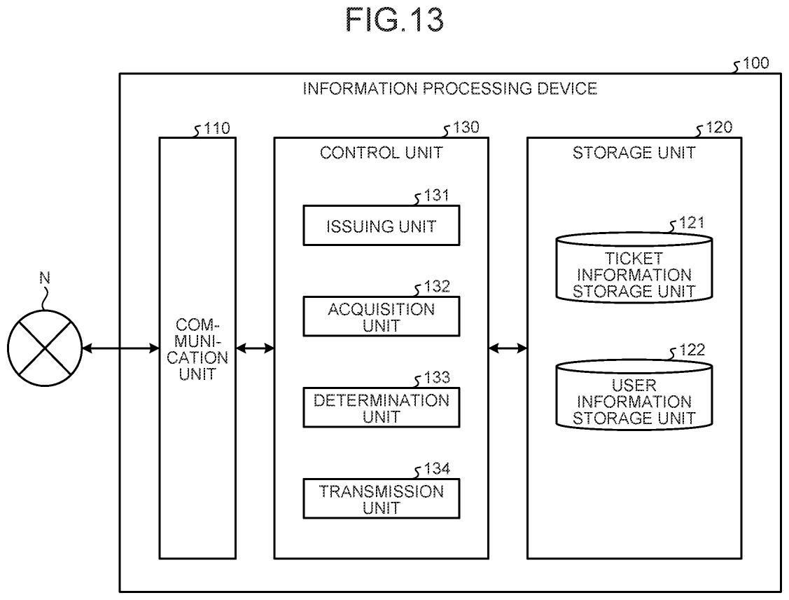

Next, a configuration of the information processing device 100 that executes information processing according to the embodiment will be described. FIG. 13 illustrates a configuration example of the information processing device 100 according to the embodiment of the present disclosure.

As illustrated in FIG. 13, the information processing device 100 includes a communication unit 110, a storage unit 120, and a control unit 130. Note that the information processing device 100 may include an input unit (e.g., keyboard and mouse) and a display unit (e.g., liquid crystal display). The input unit receives various operations from an administrator and the like who manages the information processing device 100. The display unit displays various pieces of information.

The communication unit 110 is implemented by, for example, a network interface card (NIC). The communication unit 110 is connected to the network N (e.g., Internet) by wire or wirelessly, and transmits and receives information to and from an external device, the blockchain 20, and the like via the network N.

The storage unit 120 is implemented by, for example, a semiconductor memory element, such as a random access memory (RAM) and a flash memory, or a storage device, such as a hard disk and an optical disk. The storage unit 120 includes a ticket information storage unit 121 and a user information storage unit 122. Hereinafter, each storage unit will be described in order.

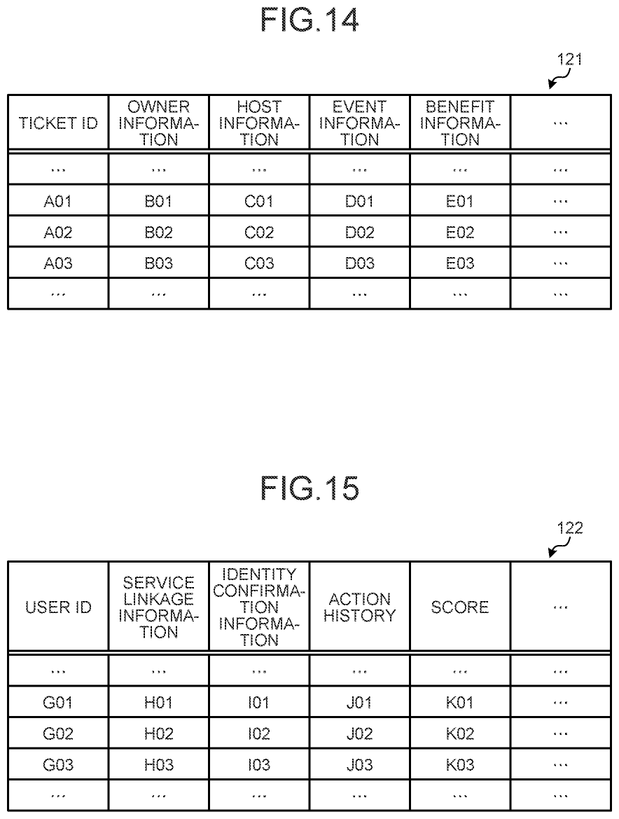

As illustrated in FIG. 14, the ticket information storage unit 121 stores information on a ticket associated with an event. FIG. 14 illustrates one example of the ticket information storage unit 121 according to the embodiment of the present disclosure. In the example of FIG. 14, the ticket information storage unit 121 includes items such as “ticket ID”, “owner information”, “host information”, “event information”, and “benefit information”. Note that, although FIGS. 14 and 15 conceptually illustrate information stored in the storage unit 120 as “A01”, actually, the storage unit 120 stores each piece of information to be described later.

The “ticket ID” is identification information for identifying a ticket. The ticket ID may include information indicating an NFT associated with the ticket.

The “owner information” relates to a user who owns the NFT. The owner information may be read as an address of a wallet of the user who owns the NFT in the blockchain 20. The owner information may include a history indicating that the NFT has been transferred.

The “host information” relates to a host of an event associated with the ticket. The host information includes, for example, information such as a name of the host, service provided by the host, and a condition for secondary use set in the ticket by the host.

The “event information” relates to the event associated with the ticket. The event information includes information such as details, a performer, the date and time, and a venue of the event. The event information may be changed in response to a request from the host or the like. For example, even in a case where the event is canceled after the sale of the ticket or in a case where the performer is changed, the user can use the ticket without collection of the ticket by changing the event information.

The “benefit information” relates to a benefit offered to the ticket. The benefit information includes information on a benefit that can be enjoyed by the user, such as that a used ticket can be used as a coupon in a predetermined place and can be exchanged for an item of a game.

Next, the user information storage unit 122 will be described. As illustrated in FIG. 15, the user information storage unit 122 stores information on a user who uses the service. FIG. 15 illustrates one example of the user information storage unit 122 according to the embodiment of the present disclosure. In the example of FIG. 15, the user information storage unit 122 includes items such as “user ID”, “service linkage information”, “identity confirmation information”, “action history”, and “score”.

The “user ID” is identification information for identifying a user who uses the service. The user ID is issued in response to a request from the user, for example, when the user first uses the service. Furthermore, the user ID may include information (e.g., address of wallet on blockchain 20) for identifying the user on the blockchain 20.

The “service linkage information” indicates information linked between pieces of service used by the user. For example, it is assumed that the administrator of the information processing device 100, the host of the event, and other external service have released a plurality of pieces of service such as a fan club, an online fan community, and a game application. In this case, the information processing device 100 links pieces of information on the user who uses the pieces of service with each other in response to a request from each piece of service or the user. Then, the information processing device 100 links the fact that a user identified by a user ID “G01” uses first service and second service and a use history and a charge amount in each of the first service and the second service with each other, and stores those linked with each other as the service linkage information. This enables the user identified by the user ID “G01” to collectively use the use histories in the pieces of service as his/her own use history in a case where the user uses a plurality of pieces of service.

The “identity confirmation information” is used for confirming the identity of the user in a case where the user participates in the event. For example, the identity confirmation information includes an address, a name, and face image data of the user. Note that the identity confirmation information may include biological information such as a fingerprint of the user.

The “action history” is a history of actions of the user in the service. The action history includes, for example, use time, the number of times of use, and use frequency of the user in the service, an amount of charge to the service, and a history of ticket purchase in the past. Furthermore, the action history may include information indicating behavior of the user to the service. For example, the action history may include a history of an attempt of the user to perform unauthorized processing on the service and a history of unauthorized ticket transactions.

The “score” indicates a credibility score of the user in the service. The information processing device 100 calculates the credibility score of the user based on a history of various actions of the user in the service. For example, the information processing device 100 may calculate the score to be higher as the use time, the number of times of use, and the use frequency of the user in the service are increased. Furthermore, the information processing device 100 may calculate the score of the user in a predetermined state to be high. The predetermined state includes a state in which the user holds a rare card distributed in the fan community. Furthermore, the information processing device 100 may calculate the score of the user who has a higher total amount of charge to the service in the past to be higher.

As illustrated in FIGS. 14 and 15, the information processing device 100 stores the owner information of the NFT, the ticket, and the user ID in association with each other. Note that the information stored in the information processing device 100 may be stored on the blockchain 20.

Returning to FIG. 13, the description will be continued. The control unit 130 is implemented by, for example, a central processing unit (CPU), a micro processing unit (MPU), and a graphics processing unit (GPU) executing a program (e.g., information processing program according to present disclosure) stored in the information processing device 100 by using a random access memory (RAM) or the like as a work area. Furthermore, the control unit 130 is a controller, and may be implemented by an integrated circuit such as an application specific integrated circuit (ASIC) and a field programmable gate array (FPGA).

As illustrated in FIG. 13, the control unit 130 includes an issuing unit 131, an acquisition unit 132, a determination unit 133, and a transmission unit 134. The control unit 130 implements or executes a function and an operation of information processing to be described below. Note that the internal configuration of the control unit 130 is not limited to the configuration in FIG. 13. Another configuration may be adopted as long as the configuration performs information processing to be described later.

The issuing unit 131 controls issuance of various pieces of information. The issuing unit 131 corresponds to the electronic ticket issuing system 51, the personal credential issuing system 52, the electronic ticket system 21, the DID system 22, and the like in FIG. 1.

The issuing unit 131 issues an NFT, which is a non fungible token in the blockchain 20.

For example, the issuing unit 131 issues the NFT in a private blockchain in which only a node permitted by the administrator can participate. The issuing unit 131 issues the NFT in the private blockchain, and can thereby issue the NFT more quickly and inexpensively than in a case where the issuing unit 131 issues the NFT in a public blockchain. Note that the issuing unit 131 may issue the NFT in the public blockchain in response to a request from the host.

Furthermore, the issuing unit 131 may issue the NFT after defining a method of transfer of a ticket associated with the NFT in the smart contract of the blockchain 20. An issuer of the ticket, the host of the event, or the external service may determine the method of transfer of a ticket.

For example, the issuing unit 131 may issue the NFT after defining, as the method of transfer, a price in a case where the user distributes the ticket or a price to be returned to a person related to the ticket in a case where the ticket is distributed. Specifically, the issuing unit 131 defines an upper limit and a lower limit of the price in the case where the user secondarily distributes the ticket, and defines a ratio of the price to be returned to the person related to the ticket in a case where the ticket is secondarily sold. Note that, in the smart contract, the issuing unit 131 may set, as the person related to the ticket, a target to whom the revenue is to be returned, such as the host of the event related to the ticket and the author of the content to be provided in the event. For example, the issuing unit 131 can automatically return the revenue at the time of secondary distribution by setting, in the smart contract, an address of the blockchain 20 to which the revenue is to be returned.

Furthermore, the issuing unit 131 may define, as the method of transfer, a period during which the user can distribute the ticket or a condition of a third party to which the ticket can be distributed. For example, the issuing unit 131 defines a condition that a time period when the user secondarily distributes the ticket is limited to a few days before the start of the event and a condition that a target to whom the ticket is to be distributed is limited to users who participate in the fan community. For example, the issuing unit 131 describes the time period of distribution of the NFT in the smart contract, and describes a condition that a destination of transfer of the NFT is limited to users stored in the user information storage unit 122.

The acquisition unit 132 acquires various pieces of information. The acquisition unit 132 corresponds to the personal credential issuing system 52, the information linkage system 53, the electronic ticket system 21, the DID system 22, and the like in FIG. 1.

The acquisition unit 132 acquires information on a user who owns an NFT issued by the issuing unit 131. For example, the acquisition unit 132 acquires information for identifying the user who owns the NFT (e.g., address of user), and stores the information in the ticket information storage unit 121 as the owner information.

Furthermore, the acquisition unit 132 acquires, as the information on the user, a user ID, which is personal identification information managed in the blockchain 20. Such a user ID is, for example, a decentralized ID referred to as DID, and can link with identity confirmation information in various pieces of external service and a predetermined certificate authority (CA). Then, the acquisition unit 132 stores the information on the user who owns the NFT and the user ID, which is identification information of the user who uses the service, in the user information storage unit 122 in association with each other.

Furthermore, the acquisition unit 132 acquires identity confirmation information of the user registered in association with the user ID. For example, when receiving a ticket purchase request from the user, the acquisition unit 132 acquires the identity confirmation information of the user via the user interface in FIG. 6. Note that the acquisition unit 132 may preliminarily acquire the identity confirmation information of the user when the user ID is issued or use of the service is received.

Furthermore, when the user intends to use the ticket, the acquisition unit 132 may acquire information for verifying the identity confirmation information of the user registered in association with the user ID. For example, the acquisition unit 132 may verify identity of the user by acquiring a name and a telephone number of the user and collating the name and the telephone number of the user with the identity confirmation information of the user registered in association with the user ID. Alternatively, the acquisition unit 132 may acquire a fingerprint and face image data of the user.

Furthermore, when the ticket associated with the NFT is sold, the acquisition unit 132 may acquire a history of actions of the user related to the ticket as information on the user who is to purchase the ticket (in other words, user corresponding to transfer destination of NFT). The history of actions of the user related to the ticket is, for example, a history of actions in a case where the user uses the service related to the ticket. For example, the acquisition unit 132 may acquire, as the history of actions of the user, a state of participation in the service or the event related to the ticket or a charge amount in the past. The acquisition unit 132 stores the acquired information in the user information storage unit 122 in association with the user ID. Furthermore, the acquisition unit 132 may acquire various pieces of data from the storage unit 120 in accordance with processing of each processing unit.

Furthermore, the acquisition unit 132 may acquire information on a benefit presented from the service related to the ticket from the host of the event or the external service. For example, the acquisition unit 132 acquires information indicating that electronic assets (digital assets) such as a trading card and an item capable of being used in the fan community and the game application related to the ticket are given to the user who has used the ticket. In this case, the acquisition unit 132 stores received information on a benefit in the ticket information storage unit 121 in association with the ticket ID and the like.

When receiving a ticket purchase request from the user, the determination unit 133 determines whether or not to accept the purchase request. The determination unit 133 corresponds to the electronic ticket issuing system 51, the information linkage system 53, the electronic ticket system 21, the DID system 22, and the like in FIG. 1.

When ownership of an NFT issued by the issuing unit 131 is transferred, the determination unit 133 determines whether or not to offer a benefit related to transfer of the ownership to the user, who is a transfer destination, based on information on the user who is the transfer destination.

Specifically, the determination unit 133 determines whether or not to offer the benefit related to transfer of the ownership to the user who is the transfer destination based on the history of actions of the user who is a transfer destination of the NFT acquired by the acquisition unit 132. More specifically, the determination unit 133 determines whether or not to offer the benefit related to the transfer of the ownership to the user who is the transfer destination based on the state of participation in the service or the event related to the ticket of the user who is the transfer destination or the charge amount in the past.

For example, the determination unit 133 calculates a probability that the user wins the ticket based on the credibility score derived based on the history of actions of the user. Then, the determination unit 133 determines whether to give the ticket to the user (in other words, whether or not to sell ticket to user) based on the calculated probability. In this case, the user obtains, as a benefit, a right to win the ticket more easily than other users. Furthermore, the determination unit 133 may determine a benefit to be offered to the user based on the credibility score. For example, the determination unit 133 may make a determination such that a user having a higher credibility score is offered a benefit having a relatively higher value. Specifically, the determination unit 133 may make a determine such that the user having a higher credibility score has a higher ticket winning probability. Note that the determination unit 133 may give not only the ticket winning probability but, for example, a right to be allocated a seat having a higher value or a right to receive some special service in the event to the user as a benefit.

The transmission unit 134 transmits various pieces of information. The transmission unit 134 corresponds to the information linkage system 53, the authentication system 54, the electronic ticket system 21, the DID system 22, and the like in FIG. 1.

The transmission unit 134 transmits the ticket associated with the NFT to the user based on the information acquired by the acquisition unit 132. For example, when receiving issuance of the ticket from the user, the transmission unit 134 transmits electronic ticket data associated with the NFT to the user based on owner information of the NET acquired by the acquisition unit 132. Note that transmitting a ticket refers to, for example, processing of displaying an electronic ticket (QR code) on the user terminal 10 in response to a ticket issuance request from the user.

Furthermore, when receiving the ticket issuance request from the user, the transmission unit 134 may transmit the ticket associated with the NFT to the user in a case where the identity of the user is verified. That is, the transmission unit 134 may transmit the ticket only to the user authenticated based on the identity confirmation information.

Furthermore, when the identity of the user who owns the NFT is verified, the transmission unit 134 may transmit, to the user, the preliminarily registered identity confirmation information of the user or information indicating that the identity of the user has been verified.

For example, when the user or the host of the event causes the user terminal 10 to read a QR code displayed at the venue, the user terminal 10 accesses the information processing device 100 based on the information indicated by the QR code. At this time, the user terminal 10 may transmit the identity confirmation information and the like input by the user together. Then, when the identity of the user is verified based on the information transmitted from the user terminal 10, the transmission unit 134 transmits information indicating that “the information processing device 100 has verified the identity of the user” to the user terminal 10. That is, the transmission unit 134 transmits not the identity confirmation information itself of the user but information indicating that identity authentication has already been completed on the side of the information processing device 100 by a predetermined authentication means. The host of the event can authenticate the user based on the information indicating that “the information processing device 100 has verified the identity of the user” displayed on the screen of the user terminal 10. Note that the transmission unit 134 may transmit some pieces of identity confirmation information optionally selected by the user. This enables the user to perform authentication that does not require the identity confirmation information itself for performing identity confirmation, that is, authentication based on a so-called zero-knowledge proof.

Furthermore, the transmission unit 134 may transmit a benefit to the user who has transmitted the ticket based on information on the benefit associated with the ticket. Specifically, the transmission unit 134 transmits assets that can be used in the service related to the ticket or a voucher that can be used in the service related to the ticket to the user as a benefit.

For example, the transmission unit 134 transmits, to the user terminal 10, electronic assets such as a trading card and an item that can be used in the service related to the ticket and a coupon ticket that can be used in a shop near an event venue. In this case, as illustrated in, for example, FIG. 11, the user terminal 10 may display the fact that the user terminal 10 has acquired the benefit offered to the used ticket. Note that the transmission unit 134 may transmit various pieces of information as a benefit in response to a request from the host and the external service. For example, the transmission unit 134 may transmit digital content of an electronic book related to the event, invitation and attracting advertisement of another event related to the event, an item or a character that can be used in a blockchain game, music, an image, and the like.

Furthermore, the transmission unit 134 may refer to a transaction history of the NFT in the blockchain, and, when a transaction history conforming with a rule of the method of transfer of a ticket associated with the NFT is verified, transmit the ticket associated with the NFT to the user. As described above, the issuing unit 131 can define a rule of secondary distribution of a ticket and the like, and issue an NFT. Furthermore, a transaction history (transaction data) of the NFT can be referred to on the blockchain 20. This enables the transmission unit 134 to verify whether or not the user has conducted a transaction in conformity with a condition of the secondary distribution set by the host and the like in a case where the transmission unit 134 receives a ticket issuance request. The transmission unit 134 can then determine whether or not to transmit a valid ticket based on a verification result.

Furthermore, the transmission unit 134 may authenticate the validity of a ticket when the user intends to use the ticket after the ticket is issued. Specifically, when the acquisition unit 132 acquires a ticket use request, the transmission unit 134 refers to a transaction history of the NFT in the blockchain 20, and, when a transaction history conforming with a rule of the method of transfer of a ticket associated with the NFT is verified, transmits information that proves the validity of the ticket associated with the NFT. The information that proves the validity of a ticket indicates that a ticket issuing side has verified a transaction of the NFT in conformity with a predetermined rule based on transaction data on the blockchain 20, for example. For example, when the host reads a QR code at the event venue, the transmission unit 134 may transmit the information to the user. This enables the host to recognize only a user who has conducted a transaction in conformity with a rule defined by the host himself/herself as a participant of the event.

### 1-4. Procedure of Information Processing According to Embodiment

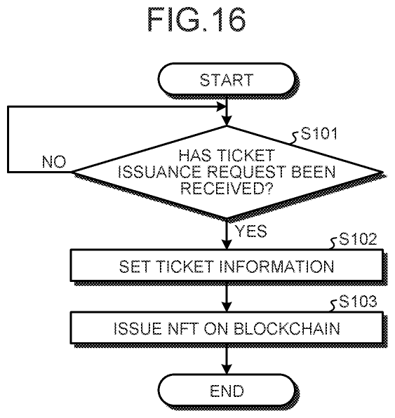

Next, a procedure of information processing according to the embodiment will be described with reference to FIGS. 16 to 20. First, a flow of issuing processing according to the embodiment of the present disclosure will be described with reference to FIG. 16. FIG. 16 is a flowchart (1) illustrating the procedure of the information processing according to the embodiment of the present disclosure.

As illustrated in FIG. 16, the information processing device 100 determines whether or not a ticket issuance request has been received from the host or the like (Step S101). When the request has not been received (Step S101; No), the information processing device 100 stands by until the request is received.

In contrast, when the request has been received (Step S101; Yes), the information processing device 100 sets ticket information that defines a rule of secondary distribution and the like in accordance with intention of the host and the like (Step S102).

Then, the information processing device 100 issues an NFT on the blockchain 20 in accordance with the set ticket information (Step S103).

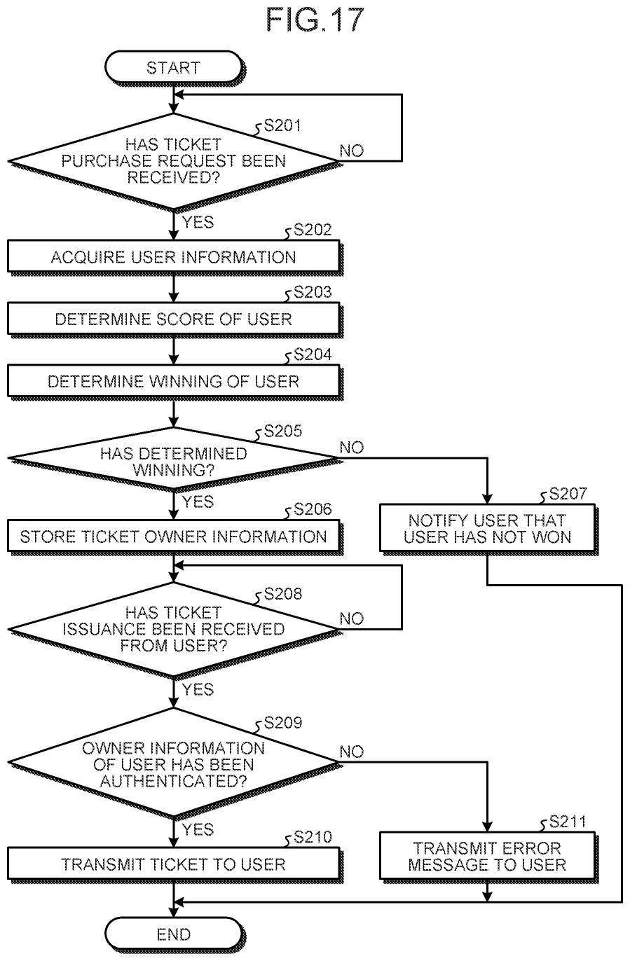

Next, a flow of ticket issuing processing according to the embodiment of the present disclosure will be described with reference to FIG. 17. FIG. 17 is a flowchart (2) illustrating the procedure of the information processing according to the embodiment of the present disclosure.

As illustrated in FIG. 17, the information processing device 100 determines whether or not a ticket purchase request has been received from the user or the like (Step S201). When the request has not been received (Step S201; No), the information processing device 100 stands by until the request is received.

In contrast, when the request has been received (Step S201; Yes), the information processing device 100 acquires user information on a person who desires to purchase a ticket (Step S202). For example, the user information includes an action history and the like of service related to the ticket. Note that the information processing device 100 may acquire identity confirmation information of the user as the user information at the timing.

The information processing device 100 determines a score of the user based on the acquired user information (Step S203). Subsequently, the information processing device 100 determines winning of the user based on the determined score (Step S204). For example, the information processing device 100 calculates a winning probability of the user based on the score, and determines whether or not the user has won based on the calculated probability.

When determining that the user has won the ticket (Step S205; Yes), the information processing device 100 stores ticket owner information (Step S206). That is, the information processing device 100 stores information indicating that an NFT associated with the ticket has moved to the wallet of the user.

In contrast, when the user is determined not to have won the ticket (Step S205; No), the information processing device 100 notifies the user that the user has not won the ticket (Step S207).

Thereafter, the information processing device 100 determines whether or not ticket issuance has been received from the user (Step S208). The ticket issuance refers to the user actually displaying the ticket on the user terminal 10 in the venue and the like, for example. When the information processing device 100 has not received the issuance (Step S208; No), the information processing device 100 stands by until the issuance is received.

In contrast, when the issuance has been received (Step S208; Yes), the information processing device 100 determines whether or not the owner information of the user who has made the ticket issuance request has been authenticated (Step S209). For example, the information processing device 100 identifies a user ID of the user who has made the ticket issuance request. When the user ID and the owner information of the NFT are associated with each other, the information processing device 100 authenticates the user as an owner of the NFT.

When the owner information of the user has been successfully authenticated (Step S209; Yes), the information processing device 100 transmits the ticket associated with the NFT to the user (Step S210). In contrast, when the owner information of the user has not been successfully authenticated (Step S209; No), the information processing device 100 transmits, to the user, an error message indicating that the ticket cannot be issued (Step S211).

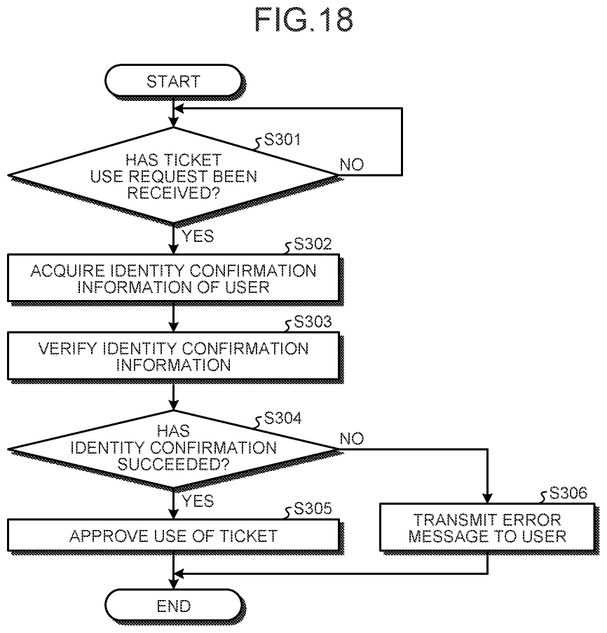

Next, a flow of ticket use processing according to the embodiment of the present disclosure will be described with reference to FIG. 18. FIG. 18 is a flowchart (3) illustrating the procedure of the information processing according to the embodiment of the present disclosure.

As illustrated in FIG. 18, the information processing device 100 determines whether or not a ticket use request has been received from the user in the venue of the event or the like (Step S301). When the request has not been received (Step S301; No), the information processing device 100 stands by until the request is received.

In contrast, when the request has been received (Step S301; Yes), the information processing device 100 acquires the identity confirmation information of the user (Step S302). For example, the information processing device 100 identifies the user ID based on a QR code of the ticket displayed on the user terminal 10, and acquires the identity confirmation information stored in association with the user ID. Then, the information processing device 100 verifies the acquired identity confirmation information (Step S303).

Then, the information processing device 100 determines whether or not the identity confirmation has succeeded (Step S304). When the identity confirmation has succeeded (Step S304; Yes), the information processing device 100 approves the use of the ticket (Step S305). Note that not the information processing device 100 but the host device 200 and the like may execute the processing. Furthermore, when the identity confirmation has failed (Step S304; No), the information processing device 100 transmits, to the user, an error message indicating that the ticket cannot be used (Step S306).

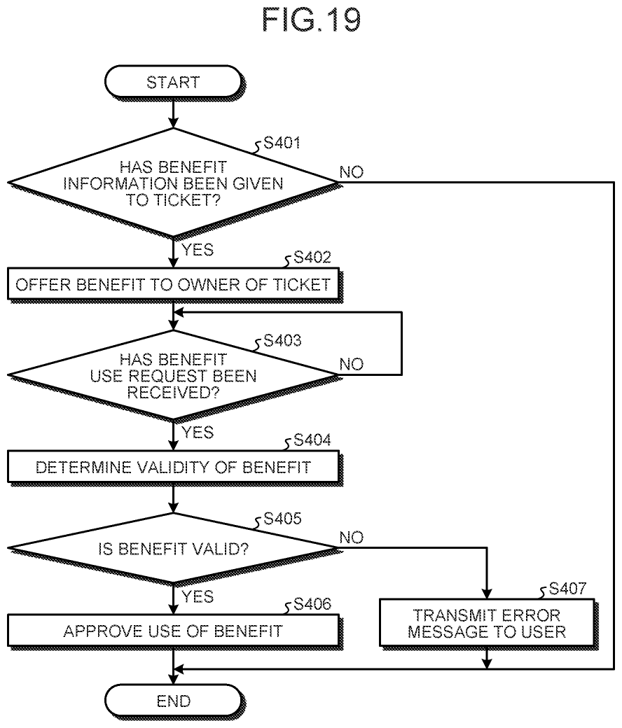

Next, a flow of benefit offering processing according to the embodiment of the present disclosure will be described with reference to FIG. 19. FIG. 19 is a flowchart (4) illustrating the procedure of the information processing according to the embodiment of the present disclosure.

As illustrated in FIG. 19, the information processing device 100 determines whether benefit information has been given to the ticket used by the user (Step S401). When the benefit information has not been given (Step S401; No), the information processing device 100 ends the processing.

In contrast, when the benefit information has been given (Step S401; Yes), the information processing device 100 offers a benefit to the owner of the ticket in accordance with the benefit information (Step S402).

Thereafter, the information processing device 100 determines whether or not a benefit use request has been received from the user (Step S403). When the request has not been received (Step S403; No), the information processing device 100 stands by until the request is received.

In contrast, when the request has been received (Step S403; Yes), the information processing device 100 determines the validity of the benefit (Step S404). For example, the information processing device 100 determines an expiration date of the benefit, a condition of use, and the like.

When determining that the benefit is valid (Step S405; Yes), the information processing device 100 approves the use of the benefit (Step S406). In contrast, when determining that the benefit is not valid (Step S405; No), the information processing device 100 transmits, to the user, an error message indicating that the benefit cannot be used (Step S407).

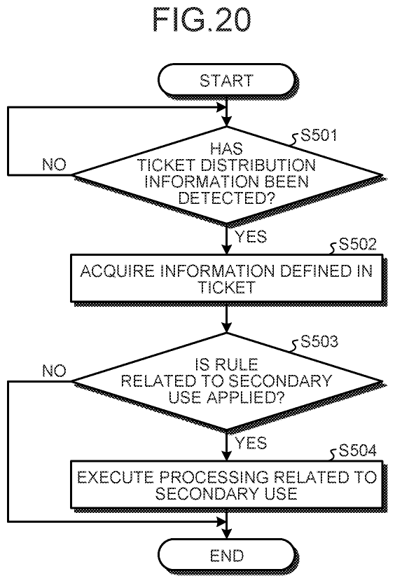

Next, a flow of processing of secondary use of a ticket according to the embodiment of the present disclosure will be described with reference to FIG. 20. FIG. 20 is a flowchart (5) illustrating the procedure of the information processing according to the embodiment of the present disclosure.

As illustrated in FIG. 20, the information processing device 100 determines whether or not distribution information on the ticket used by the user has been detected (Step S501). In other words, the information processing device 100 determines whether or not the owner information of the NFT owned in the wallet of the user has been updated. When the distribution information has not been detected (Step S501; No), the information processing device 100 stands by until the distribution information is detected.

In contrast, when the distribution information has been detected (Step S501; Yes), the information processing device 100 acquires information defined in the ticket (Step S502). Then, the information processing device 100 determines whether or not the rule related to the secondary use is applied in the NFT from which the user has been transferred (Step S503).

When determining that the rule related to the secondary use is applied (Step S503; Yes), the information processing device 100 executes processing related to the secondary use (Step S504). For example, the information processing device 100 executes processing of returning a part of the revenue generated in the secondary use to a right holder or the like of the ticket. In contrast, when determining that the rule related to the secondary use is not applied (Step S503; No), the information processing device 100 ends the processing.

Note that the information processing device 100 is not required to execute the processing related to the secondary use of the ticket. That is, the processing related to the secondary use of the ticket may be automatically executed by DApps and the like that operate on the blockchain 20 in accordance with a rule preliminarily described in the smart contract or the like.

### 1-5. Variation of Embodiment

(1-5-1. Operation as Information Processing System)

In the above-described embodiment, an example in which the information processing device 100 executes the information processing according to the present disclosure has been described. The information processing according to the present disclosure, however, may be executed by cooperation of the information processing device 100 managed by the ticket issuing side, the user terminal 10, the host device 200, and the external service device 300. That is, the information processing according to the present disclosure may be executed not only by those described in the embodiment but by the information processing system 1 including various devices.

(1-5-2. Use of DID)

In the above-described embodiment, an example in which a user ID (DID) is used as user identification information related to the service has been described. The DID is, however, an identifier having uniqueness and managed on the blockchain 20, and may be used for various applications.

For example, the information processing device 100 may acquire, based on the DID, information such as a history of external service used by the user so far, purchase and use histories of various tickets, the content of an owned NFT, and a purchase and transfer of the NFT. Then, the information processing device 100 may create, based on these histories, information for identifying a willingness to buy and a field of interest of the user, that is, a so-called token graph.

Furthermore, the information processing device 100 may identify a plurality of pieces of service used by the user, and create a list common to the plurality of pieces of service based on the DID. For example, the information processing device 100 may create a list indicating that the user has an extremely strong willingness to buy and a list indicating that attention should be paid to actions of the user, that is, a so-called blacklist.

(1-5-3. Mode of Secondary Distribution)

In the above-described embodiment, a mode in which the first user 11 assigns a ticket to the second user 12 has been described as a mode of the secondary distribution. The mode of the secondary distribution is, however, not limited thereto.

For example, the event host may assign an issued NFT to an external business operator (e.g., municipality and public organization) or a ticket dealer. The business operator assigned the NFT may further assign the NFT associated with the ticket, or widely sell the NFT to the public. This is achieved by features of the NFT in which an owner can be transferred and a transaction history can be referred to. In one example, a local government assigned an NFT by the event host may set the NFT as a thank-you gift for hometown tax payment. As described above, the information processing device 100 can distribute a ticket in a mode no different from that of a physical ticket by associating the NFT with the ticket.

### 2. Other Embodiments

The processing according to the above-described embodiment may be carried out in various forms different from the form of the above-described embodiment.

For example, among pieces of processing described in the above-described embodiment, all or part of the processing described as being performed automatically can be performed manually, or all or part of the processing described as being performed manually can be performed automatically by a known method. In addition, the processing procedures, specific names, and information including various pieces of data and parameters in the above document and drawings can be optionally changed unless otherwise specified. For example, various pieces of information in each figure are not limited to the illustrated information.

Furthermore, each component of each illustrated device is functional and conceptual, and does not necessarily need to be physically configured as illustrated. That is, the specific form of distribution/integration of each device is not limited to the illustrated one, and all or part of the device can be configured in a functionally or physically distributed/integrated manner in any unit in accordance with various loads and use situations.

Furthermore, the above-described embodiment and variations can be appropriately combined as long as the processing contents do not contradict each other.

Furthermore, the effects described in the present specification are merely examples and not limitations. Other effects may be exhibited.

### 3. Effects of Information Processing Device According to Present Disclosure

As described above, the information processing device (information processing device 100 in embodiment) according to the present disclosure includes an issuing unit (issuing unit 131 in embodiment), an acquisition unit (acquisition unit 132 in embodiment), and a transmission unit (transmission unit 134 in embodiment). The issuing unit issues a non fungible token (NFT) in the blockchain. The acquisition unit acquires information on a user who owns the NFT issued by the issuing unit. The transmission unit transmits a ticket associated with the NFT to the user based on the information acquired by the acquisition unit.

As described above, the information processing device according to the present disclosure associates, with the ticket, the NFT having a feature of being “non fungible” and a feature of “transfer of ownership” and “tracking of transaction history” being possible. This enables the information processing device to achieve a ticket system that can optionally transfer ownership while inhibiting unauthorized copying and resale.

Furthermore, the acquisition unit acquires, as the information on the user who owns the NFT, personal identification information managed in the blockchain.

As described above, the information processing device according to the present disclosure can transmit a ticket only to a user who has a legitimate right by acquiring the personal identification information managed in the blockchain and verifying whether the personal identification information and the ownership of the NFT are associated with each other.

Furthermore, the acquisition unit acquires information for verifying the identity confirmation information of the user registered in association with the personal identification information. When the identity of the user is verified, the transmission unit transmits the ticket associated with the NFT to the user.

As described above, the information processing device according to the present disclosure can inhibit unauthorized processing such as falsification of the identity confirmation information by managing the identity confirmation information in association with the personal identification information managed on the blockchain.

Furthermore, when the identity of the user who owns the NET is verified, the transmission unit transmits, to the user, the preliminarily registered identity confirmation information of the user or information indicating that the identity of the user has been verified.

As described above, the information processing device according to the present disclosure can perform identity confirmation without putting a burden on the side of the host of the event by transmitting, to the user, the identity confirmation information of the user or information indicating that the identity of the user has been verified. This enables the host to smoothly hold an event such as an idol handshake event and studio viewing even though the event requires identity confirmation of participants in terms of security. Furthermore, the user can perform authentication processing based on a zero-knowledge proof, in which the user is authenticated without presenting identity confirmation information of the user himself/herself, so that leakage of personal information of the user can be inhibited.

Furthermore, the issuing unit issues an NFT in a private blockchain in which only a node permitted by an administrator can participate.

As described above, the information processing device according to the present disclosure can inhibit a fee (referred to as GAS fee in, for example, Ethereum) related to block generation and transaction verification by using the private blockchain. Furthermore, the information processing device can inhibit a malicious participant from participating in the blockchain by using the private blockchain, and improve security strength.

Furthermore, the issuing unit issues the NFT after defining a method of transfer of a ticket associated with the NFT in the smart contract of the blockchain.

As described above, the information processing device according to the present disclosure can determine a transfer method in complying with intention of the host and the like and issue an NFT, so that the information processing device can inhibit unauthorized resale.

Furthermore, the issuing unit defines, as the method of transfer, a price in a case where the user distributes the ticket or a price to be returned to a person related to the ticket in a case where the ticket is distributed.

As described above, the information processing device according to the present disclosure can exclude a malicious reseller who, for example, sets an unreasonably high price by setting a price condition at the time of secondary distribution, and activate a secondary market of tickets.

Furthermore, the issuing unit defines, as the method of transfer, a period during which the user can distribute the ticket or a condition of a third party to which the ticket can be distributed.

As described above, the information processing device according to the present disclosure can achieve ticket distribution in complying with the intention of the host also in the secondary market by setting a condition of a transfer destination at the time of secondary distribution.

Furthermore, the transmission unit refers to a transaction history of the NFT in the blockchain, and, when a transaction history conforming with a rule of the method of transfer of a ticket associated with the NFT is verified, transmits the ticket associated with the NFT to the user.

As described above, the information processing device according to the present disclosure can adjust event participants in complying with the intension of the host by, for example, not allowing a user who has conducted an unauthorized transaction to use the ticket by verifying the traceability of the NFT.

Furthermore, the acquisition unit acquires the ticket use request transmitted by the transmission unit. When the ticket use request has been acquired, the transmission unit refers to a transaction history of the NFT in the blockchain. When the transaction history conforming with a rule of the method of transfer of the ticket associated with the NFT is verified, the transmission unit transmits information that proves the validity of the ticket associated with the NFT.

As described above, the information processing device according to the present disclosure can prompt ethical ticket use by, for example, invalidating a ticket owned by a user who has conducted an unauthorized transaction by verifying the traceability of the NFT.

Furthermore, the information processing device further includes a determination unit that, when ownership of an NFT issued by the issuing unit is transferred, determines whether or not to offer a benefit related to transfer of the ownership to the user, who is a transfer destination, based on information on the user who is the transfer destination.

As described above, the information processing device according to the present disclosure can adjust a user who is allowed to win a ticket in complying with the intension of the host and the like by offering a benefit related to transfer to the user in accordance with the information on the user who is the transfer destination of the NFT.

Furthermore, the acquisition unit acquires a history of actions of the user who is the transfer destination. The determination unit determines whether or not to offer the benefit related to transfer of the ownership to the user who is the transfer destination based on the history of actions of the user who is a transfer destination.

As described above, the information processing device according to the present disclosure can prompt aggressive use of the user in the service related to the ticket by offering the benefit to the user based on the history of actions of the user.

Furthermore, the acquisition unit acquires, as the history of actions of the user who is the transfer destination, a state of participation in the service or the event related to the ticket or a charge amount in the past. The determination unit determines whether or not to offer the benefit related to the transfer of the ownership to the user who is the transfer destination based on the state of participation in the service or the event related to the ticket or the charge amount in the past.

As described above, the information processing device according to the present disclosure can increase satisfaction of a user who has made a large contribution by, for example, giving preferential treatment to the user who has made a larger contribution to the service by offering the benefit to the user based on the service history.

Furthermore, the acquisition unit acquires information on a benefit presented from the service related to the ticket. The transmission unit transmits the benefit to the user who has transmitted the ticket based on the information on the benefit.

As described above, the information processing device according to the present disclosure can enhance an added value related to a ticket by, for example, allowing the user to use the benefit based on the ticket even after the ticket is used by taking advantage of the feature of the uniqueness of an NFT.

Furthermore, the transmission unit transmits assets that can be used in the service related to the ticket or a voucher that can be used in the service related to the ticket to the user as a benefit.

As described above, the information processing device according to the present disclosure can enhance the willingness of a user to buy a ticket and expand ticket use to other service by, for example, offering predetermined electronic assets to the user as a benefit by taking advantage of the fact that the ticket is associated with the NFT.

### 4. Hardware Configuration

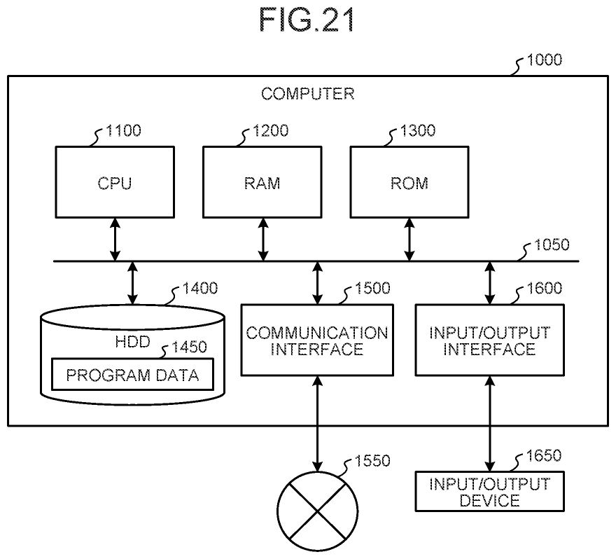

An information device such as the information processing device 100 according to the above-described embodiment is implemented by a computer 1000 having a configuration as illustrated in FIG. 21, for example. An example of the information processing device 100 according to the embodiment will be described below. FIG. 21 is a hardware configuration diagram illustrating one example of the computer 1000 that implements the function of the information processing device 100. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates based on a program stored in the ROM 1300 or the HDD 1400, and controls each unit. For example, the CPU 1100 develops a program stored in the ROM 1300 or the HDD 1400 on the RAM 1200, and executes processing corresponding to various programs.

The ROM 1300 stores a boot program such as a basic input output system (BIOS) executed by the CPU 1100 at the time when the computer 1000 is started, a program depending on the hardware of the computer 1000, and the like.

The HDD 1400 is a computer-readable recording medium that non-transiently records a program executed by the CPU 1100, data used by the program, and the like. Specifically, the HDD 1400 is a recording medium that records an information processing program according to the present disclosure. The information processing program is one example of program data 1450.

The communication interface 1500 connects the computer 1000 with an external network 1550 (e.g., Internet). For example, the CPU 1100 receives data from another device, and transmits data generated by the CPU 1100 to another device via the communication interface 1500.

The input/output interface 1600 connects an input/output device 1650 with the computer 1000. For example, the CPU 1100 receives data from an input device such as a keyboard and a mouse via the input/output interface 1600. Furthermore, the CPU 1100 transmits data to an output device such as a display, a speaker, and a printer via the input/output interface 1600. Furthermore, the input/output interface 1600 may function as a medium interface that reads a program and the like recorded in a predetermined recording medium. The medium includes, for example, an optical recording medium such as a digital versatile disc (DVD) and a phase change rewritable disk (PD), a magneto-optical recording medium such as a magneto-optical disk (MO), a tape medium, a magnetic recording medium, a semiconductor memory, and the like.

For example, when the computer 1000 functions as the information processing device 100 according to the embodiment, the CPU 1100 of the computer 1000 implements the functions of the control unit 130 and the like by executing an information processing program loaded on the RAM 1200. Furthermore, the HDD 1400 stores an information processing program according to the present disclosure and data in the storage unit 120. Note that the CPU 1100 reads the program data 1450 from the HDD 1400 and executes the program data 1450. In another example, the CPU 1100 may acquire these programs from another device via the external network 1550.

Note that the present technology can also have the configurations as follows.

(1)

An information processing device comprising:
an issuing unit that issues a non fungible token (NFT) in a blockchain;
an acquisition unit that acquires information on a user who owns the NFT issued by the issuing unit; and
a transmission unit that transmits a ticket associated with the NFT to the user based on the information acquired by the acquisition unit.
   (2)

The information processing device according to (1),
wherein the acquisition unit acquires personal identification information managed in a blockchain as the information on a user who owns the NFT.
   (3)

The information processing device according to (2),
wherein the acquisition unit acquires information for verifying identity confirmation information of a user registered in association with the personal identification information, and
the transmission unit transmits the ticket associated with the NFT to the user when identity of the user is verified.
   (4)

The information processing device according to (3),
wherein, when the identity of the user who owns the NFT is verified, the transmission unit transmits, to the user, preliminarily registered identity confirmation information of the user or information indicating that the identity of the user has been verified.
   (5)

The information processing device according to any one of (1) to (4),
wherein the issuing unit issues the NFT in a private blockchain in which only a node permitted by an administrator can participate.
   (6)

The information processing device according to any one of (1) to (5),
wherein the issuing unit issues the NFT after defining a method of transfer of a ticket associated with the NFT in a smart contract of the blockchain.
   (7)

The information processing device according to (6),
wherein the issuing unit defines, as the method of transfer, a price in a case where the user distributes the ticket or a price to be returned to a person related to the ticket in a case where the ticket is distributed.
   (8)

The information processing device according to (6) or (7),
wherein the issuing unit defines, as the method of transfer, a period during which the user can distribute the ticket or a condition of a third party to which the ticket can be distributed.
   (9)

The information processing device according to any one of (6) to (8),
wherein the transmission unit refers to a transaction history of the NFT in the blockchain, and, when a transaction history conforming with a rule of the method of transfer of a ticket associated with the NFT is verified, transmits the ticket associated with the NFT to the user.
   (10)

The information processing device according to any one of (6) to (9),
wherein the acquisition unit acquires a ticket use request transmitted by the transmission unit, and
when the ticket use request is acquired, the transmission unit refers to a transaction history of the NFT in the blockchain, and, when a transaction history conforming with a rule of the method of transfer of a ticket associated with the NFT is verified, the transmission unit transmits information that proves validity of the ticket associated with the NFT.
   (11)

The information processing device according to any one of (1) to (10), further comprising,
a determination unit that, when ownership of an NFT issued by the issuing unit is transferred, determines whether or not to offer a benefit related to transfer of the ownership to a user, who is a transfer destination, based on information on the user who is the transfer destination.
   (12)

The information processing device according to (11),
wherein the acquisition unit acquires a history of actions of the user, who is the transfer destination, and
the determination unit determines whether or not to offer the benefit related to transfer of the ownership to the user, who is the transfer destination, based on the history of actions of the user, who is the transfer destination.
   (13)

The information processing device according to (12),
wherein the acquisition unit acquires, as the history of actions of the user who is the transfer destination, a state of participation in service or an event related to the ticket or a charge amount in a past, and
the determination unit determines whether or not to offer the benefit related to transfer of the ownership to the user, who is the transfer destination, based on the state of participation in the service or the event related to the ticket or the charge amount in the past.
   (14)

The information processing device according to any one of (1) to (13),
wherein the acquisition unit acquires information on a benefit presented from service related to the ticket, and
the transmission unit transmits the benefit to a user who has transmitted the ticket based on the information on the benefit.
   (15)

The information processing device according to (14),
wherein the transmission unit transmits an asset that is allowed to be used in the service related to the ticket or a voucher that is allowed to be used in the service related to the ticket to the user as the benefit.
   (16)

An information processing method comprising a computer:
issuing a non fungible token (NFT) in a blockchain;
acquiring information on a user who owns the NFT that has been issued; and
transmitting a ticket associated with the NFT to the user based on the information that has been acquired.
   (17)

An information processing program for causing a computer to function as:
an issuing unit that issues a non fungible token (NFT) in a blockchain;
an acquisition unit that acquires information on a user who owns the NFT issued by the issuing unit; and
a transmission unit that transmits a ticket associated with the NFT to the user based on the information acquired by the acquisition unit.

### REFERENCE SIGNS LIST

1 INFORMATION PROCESSING SYSTEM
10 USER TERMINAL
20 BLOCKCHAIN
100 INFORMATION PROCESSING DEVICE
110 COMMUNICATION UNIT
120 STORAGE UNIT
121 TICKET INFORMATION STORAGE UNIT
122 USER INFORMATION STORAGE UNIT
130 CONTROL UNIT
131 ISSUING UNIT
132 ACQUISITION UNIT
133 DETERMINATION UNIT
134 TRANSMISSION UNIT
200 HOST DEVICE
300 EXTERNAL SERVICE DEVICE

1. An information processing device comprising:
an issuing unit that issues a non fungible token (NFT) in a blockchain;
an acquisition unit that acquires information on a user who owns the NET issued by the issuing unit; and
a transmission unit that transmits a ticket associated with the NFT to the user based on the information acquired by the acquisition unit.

2. The information processing device according to claim 1,
wherein the acquisition unit acquires personal identification information managed in a blockchain as the information on a user who owns the NFT.

3. The information processing device according to claim 2,
wherein the acquisition unit acquires information for verifying identity confirmation information of a user registered in association with the personal identification information, and
the transmission unit transmits the ticket associated with the NFT to the user when identity of the user is verified.

4. The information processing device according to claim 3,
wherein, when the identity of the user who owns the NFT is verified, the transmission unit transmits, to the user, preliminarily registered identity confirmation information of the user or information indicating that the identity of the user has been verified.

5. The information processing device according to claim 1,
wherein the issuing unit issues the NFT in a private blockchain in which only a node permitted by an administrator can participate.

6. The information processing device according to claim 1,
wherein the issuing unit issues the NFT after defining a method of transfer of a ticket associated with the NFT in a smart contract of the blockchain.

7. The information processing device according to claim 6,
wherein the issuing unit defines, as the method of transfer, a price in a case where the user distributes the ticket or a price to be returned to a person related to the ticket in a case where the ticket is distributed.

8. The information processing device according to claim 6,
wherein the issuing unit defines, as the method of transfer, a period during which the user can distribute the ticket or a condition of a third party to which the ticket can be distributed.

9. The information processing device according to claim 6,
wherein the transmission unit refers to a transaction history of the NFT in the blockchain, and, when a transaction history conforming with a rule of the method of transfer of a ticket associated with the NFT is verified, transmits the ticket associated with the NFT to the user.

10. The information processing device according to claim 6, wherein the acquisition unit acquires a ticket use request transmitted by the transmission unit, and
when the ticket use request is acquired, the transmission unit refers to a transaction history of the NFT in the blockchain, and, when a transaction history conforming with a rule of the method of transfer of a ticket associated with the NET is verified, the transmission unit transmits information that proves validity of the ticket associated with the NFT.

11. The information processing device according to claim 1, further comprising
a determination unit that, when ownership of an NFT issued by the issuing unit is transferred, determines whether or not to offer a benefit related to transfer of the ownership to a user, who is a transfer destination, based on information on the user who is the transfer destination.

12. The information processing device according to claim 11,
wherein the acquisition unit acquires a history of actions of the user, who is the transfer destination, and
the determination unit determines whether or not to offer the benefit related to transfer of the ownership to the user, who is the transfer destination, based on the history of actions of the user, who is the transfer destination.

13. The information processing device according to claim 12,
wherein the acquisition unit acquires, as the history of actions of the user who is the transfer destination, a state of participation in service or an event related to the ticket or a charge amount in a past, and
the determination unit determines whether or not to offer the benefit related to transfer of the ownership to the user, who is the transfer destination, based on the state of participation in the service or the event related to the ticket or the charge amount in the past.

14. The information processing device according to claim 1,
wherein the acquisition unit acquires information on a benefit presented from service related to the ticket, and
the transmission unit transmits the benefit to a user who has transmitted the ticket based on the information on the benefit.

15. The information processing device according to claim 14,
wherein the transmission unit transmits an asset that is allowed to be used in the service related to the ticket or a voucher that is allowed to be used in the service related to the ticket to the user as the benefit.

16. An information processing method comprising a computer:
issuing a non fungible token (NFT) in a blockchain;
acquiring information on a user who owns the NFT that has been issued; and
transmitting a ticket associated with the NFT to the user based on the information that has been acquired.

17. An information processing program for causing a computer to function as:
an issuing unit that issues a non fungible token (NET) in a blockchain;
an acquisition unit that acquires information on a user who owns the NET issued by the issuing unit; and
a transmission unit that transmits a ticket associated with the NET to the user based on the information acquired by the acquisition unit.
